(19) United States
(12) Patent Application Publication
(10) Pub. No.: US 2003/0038485 A1
(43) Pub. Date: Feb. 27, 2003

(54) Vehicle closure member latch assembly having hold open mode

(76) Inventors: Dennis D. Schwaiger, Whitmore Lake, MI (US); Curt D. Campbell, Farmington Hills, MI (US)

Correspondence Address: James A. Kushman, Brooks & Kushman P.C., 1000 Town Center, 22nd Floor, Southfield, MI, 48075-1351, US

(21) Appl. No.: 10/223,977

(22) Filed: Aug. 20, 2002

Related U.S. Application Data
(60) Provisional application No. 60/314,192, filed on Aug. 22, 2001.

(51) Int. Cl. E05C 3/06

(52) U.S. Cl. 292/201

(57) ABSTRACT

A vehicle latch assembly (10) includes a release member (40) pivotally mounted on a housing (20) for movement from a start position where a catch (24) secures a closure member striker (18) and a released position where a pawl (32) permits the catch to move to a released position. An actuating portion (42) of the release member holds the pawl (32) in a released position if the catch (24) after being released by the pawl does not move to its released position because the associated closure member remains closed. A positioning member (66) cyclically positions a drive portion (62) of an output gear (60) of a worm gear drive (54).

### CROSS-REFERENCE TO RELATED APPLICATIONS

This application claims the benefit of U.S. provisional application Serial No. 60/314,192 filed Aug. 22, 2001.

### BACKGROUND OF THE INVENTION

1. Field of the Invention

This invention relates to a vehicle closure member latch assembly and has particular utility for use with vehicle deck lids.

2. Background Art

Vehicle closure members conventionally include a latch assembly for selectively securing a striker to hold the closure member in a closed position with respect to an access opening of an associated vehicle body. For example, vehicle deck lids for which the latch assembly of the present invention has particular utility are conventionally counterbalanced to an open position by torque rods and are selectively held in the closed position by the cooperation of a latch assembly and an associated striker. Normally the striker is mounted on the vehicle body and the latch assembly is mounted on the vehicle deck lid; however, the reverse mounting is also sometimes used with the striker mounted on the vehicle deck lid and the latch assembly mounted on the vehicle body. Upon unlatching of the striker by the latch assembly, the counterbalancing provided by the torque rods moves the closure member to an open position with or without manual assistance. However, in some instances ice or snow that accumulates can prevent the opening movement of the closure member. When the unlatching of the latch assembly is provided by an electric motor drive release, this condition can result in continual electric motor driving of the drive release until the closure member is moved to its open position whereupon an associated catch of the latch assembly moves to an unlatched position in a manner that terminates the electric motor driving through the accompanying movement of the latch assembly components.

Prior art patents noted during an investigation conducted in connection with the present invention includes U.S. Pat. Nos. 5,074,603 Brackmann; 5,137,311 Brackmann-Horst; 5,938,253 Szablweski et al.; 6,109,671 Roncin et al; 6,264,253 Takaishi; and 6,267,420 Miyagawa.

### SUMMARY OF THE INVENTION

An object of the present invention is to provide an improved vehicle closure member latch assembly.

In carrying out the above object, the vehicle latch assembly of the invention is constructed to hold a closure member in a closed position with respect to a vehicle opening defined by a vehicle body member. The latch assembly is actuatable to permit movement of the closure member from the closed position to an open position so as to allow access through the vehicle opening. The construction of the latch assembly includes a housing mountable on one of the members. A catch of the latch assembly is pivotally mounted on the housing for movement between: a latched position for securing a striker mounted on the other member to hold the closure member in the closed position with respect to the vehicle body member, and an unlatched position that releases the striker and permits the closure member to move from the closed position to the open position. The catch has a pawl engagement portion. A pawl of the latch assembly is pivotally mounted on the housing for movement between: a blocking position where the pawl engages the catch to hold the catch in its latched position and thereby maintain the closure member in the closed position, and a released position where the pawl is disengaged from the catch to permit movement of the catch to the unlatched position and thereby permit movement of the closure member from the closed position to the open position. A release member of the latch assembly has an actuating portion and is pivotally mounted on the housing for actuatable movement from: a start position where the catch is held in the latched position by the pawl in its blocking position, to a released position where the actuating portion of the release member engages and moves the pawl to its released position to permit movement of the catch to its unlatched position. The pawl engagement portion of the catch engages the pawl as the catch moves from its latched position to its unlatched position as the striker is released from the catch concomitant with movement of the closure member from the closed position to the open position. The actuating portion of the release member engages the pawl to maintain the pawl in its release position when the catch does not move to its unlatched position because the closure member does not move from the closed position to the open position. An actuator of the latch assembly actuates movement of the release member from its start position to its released position to provide the pawl movement from its blocking position to its released position.

The latch assembly includes a spring that biases the catch toward its unlatched position and that biases the pawl toward its blocking position. In addition, the latch assembly includes a spring that biases the release member toward its start position. A sensor of the latch assembly senses the location of the release member.

The actuator of the latch assembly is disclosed as including an electric motor and worm gear drive that selectively moves the release member from its start position to its released position. The worm gear drive includes an output gear that is rotatively driven by the electric motor, and the output gear has a drive portion. The release member has a driven surface that is engaged by the drive portion of the output gear to move the release member from its start position to its released position.

The actuator of the latch assembly is also disclosed as including a key nut that selectively moves the release member from its start position to its released position. The key nut includes an actuating portion, and the release member has an opening that receives the actuating portion of the key nut and has a cam surface that is moved by the actuating portion of the key nut to move the release member from its start position to its released position.

The actuator of the latch assembly is further disclosed as including a remote cable release that is connected to the release member and is selectively actuatable to move the release member from its start position to its release position.

The actuator is actually disclosed as including an electric motor and a worm gear drive together with a key nut that each selectively moves the release member from its start position to its release position as well as also including a remote cable release that is connected to the release member and selectively actuatable to move the release member from its start position to its release position.

In addition to the actuator including an electric motor driven output gear having a drive portion that engages and moves the release member to move the release member from its start position to its released position, the latch assembly also includes a positioning member that is moved from a start position to a blocking position when the pawl is moved from its blocking position to its released position with respect to the catch regardless of whether or not the catch moves from its latched position to its unlatched position. The positioning member in its blocking position engages the drive portion of the output gear to position the output gear in a start position thereof in preparation for another cycle for actuating the release member for movement from its start position to its release position. A spring extends between a catch and the positioning member to bias the catch toward its unlatched position, to bias the positioning member toward its start position, and to bias the pawl toward its blocking position by engagement of the positioning member with the pawl. The positioning member has a first arm including a blocking portion that engages the drive portion of the output gear to position the output gear in its start position, and the positioning member has a second arm connected to the spring which is also connected to the catch. A sensor senses the location of the positioning member. Thus, there is a first sensor that senses the location of the release member and a second sensor that senses the location of the positioning member.

### BRIEF DESCRIPTION OF THE DRAWINGS

FIG. 1 is a side elevational view of a vehicle having a latch assembly constructed in accordance with the invention to hold a closure member, such as the rear deck lid shown, in a closed position shown by a solid line representation and to selectively permit movement thereof to an open position shown by phantom line representation.

FIG. 2 is a view of the latch assembly which is shown in a latched position holding a striker so as to maintain the closure member in its closed position.

FIG. 3 is a view that illustrates the latch assembly after actuation thereof to commence unlatching of the latch assembly.

FIG. 4 is a view that illustrates the latch assembly at a further stage of its unlatching after a striker has been released by a catch to permit opening movement of the closure member.

FIG. 5 is a view illustrating the latch assembly after it has been actuated to permit the catch to move to its unlatched position but without any such movement because the closure member is prohibited from such movement such as by accumulated ice or snow.

FIG. 6 is a view illustrating the manner in which the latch assembly is released by key nut operation.

FIG. 7 is a view of another embodiment of the latch assembly which includes a remote cable release for providing the unlatching.

FIG. 8 is a view that illustrates the remote cable release embodiment of the latch assembly after its catch has been unlatched.

### DETAILED DESCRIPTION OF THE PREFERRED EMBODIMENTS

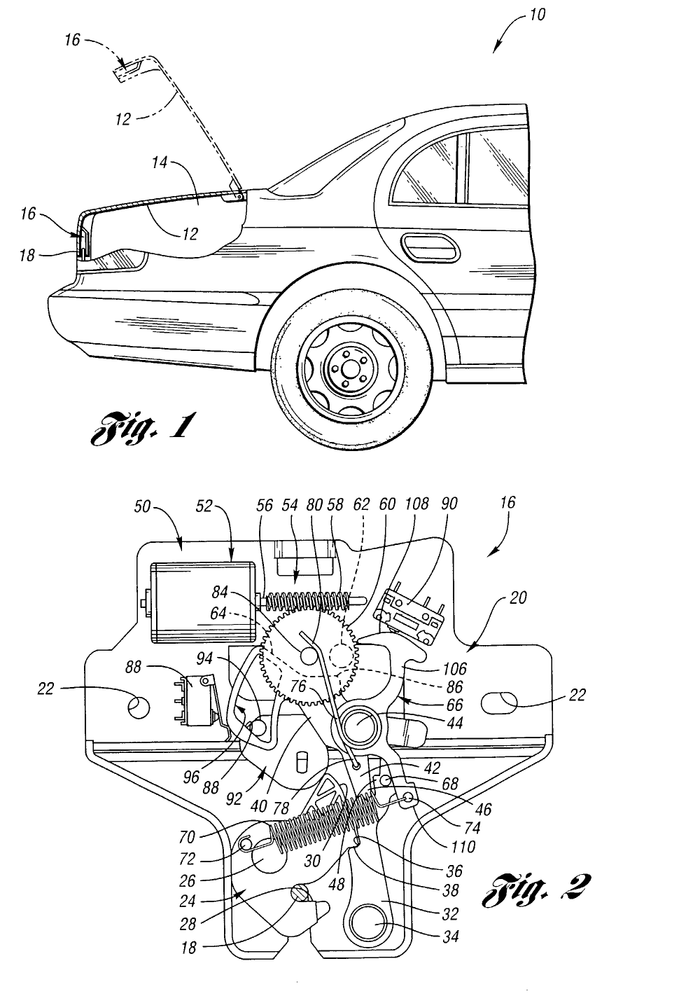

With reference to FIG. 1, a vehicle generally indicated by 10 is disclosed as including a closure member that is embodied by a rear deck lid 12 that is movable between a solid line indicated closed position and a phantom line indicated open position to permit access through a vehicle opening 14 into the associated vehicle trunk storage compartment. A latch assembly 16 constructed in accordance with the invention is illustrated as being mounted on the deck lid 12 and as cooperating with a vehicle body mounted striker 18 to hold the deck lid in its closed position and selectively permit movement thereof to its open position by actuation of the latch assembly 16 to release the striker 18 as is hereinafter more fully described. It should be appreciated that the latch assembly 16 is conventionally mounted on the closure member provided by the deck lid 12 and the striker 18 is mounted on a vehicle body member adjacent the rear of the vehicle storage compartment trunk, but the relative position can also be reversed so that the latch assembly is on the vehicle body and the striker is on the deck lid.

With reference to FIG. 2, the latch assembly 16 includes a housing 20 having fastener openings 22 for receiving suitable fasteners such as threaded studs or bolts utilized to mount the latch assembly by threaded connections. A catch 24 of the latch assembly is pivotally mounted by a pin 26 on the housing 20 for movement between a latched position shown in FIG. 2 and a released position as shown in FIG. 4. The catch 22 has a throat 28 that receives the striker 18 in its latched position of FIG. 2 so as to secure the associated deck lid closure member in its closed position. In its released position shown in FIG. 4, the catch throat 28 releases the striker 18 to permit movement of the deck lid closure member to its open position in order to permit access through the vehicle opening. Subsequent closing of the closure member causes the striker to pivot the catch 24 back to its latched position for latching as is hereinafter more fully described. The catch 24 also has a pawl engagement portion 30 whose operation is subsequently described in connection with FIG. 4.

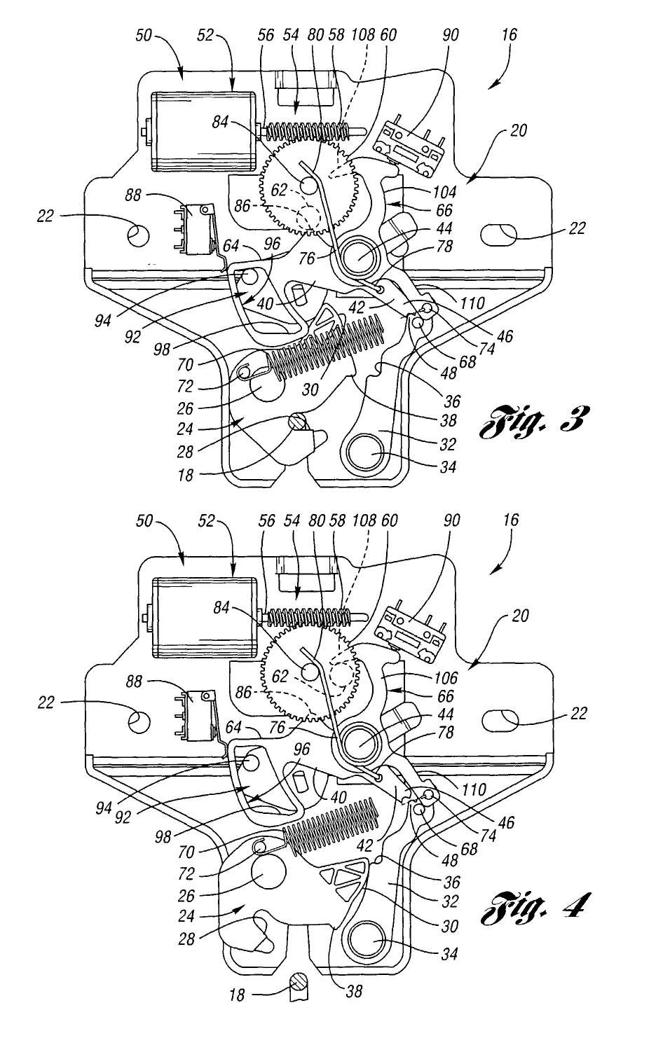

As shown in FIG. 2, the latch assembly 16 also includes a pawl 32 pivotally mounted by a pin 34 on the housing 20 for movement between the blocking position illustrated and a released position as shown in FIG. 3. In the blocking position of FIG. 2, a blocking notch 36 of the pawl receives and engages a lobe 38 of the catch 24 to hold the catch in its latched position and thereby maintain the deck lid closure member in the closed position. In the release position of FIG. 3, the pawl 32 has its notch 36 disengaged from the catch 24 at its lobe 38 to permit movement of the catch to its unlatched position shown in FIG. 4 so that the striker 18 is released to permit movement of the deck lid closure member from the closed position to the open position.

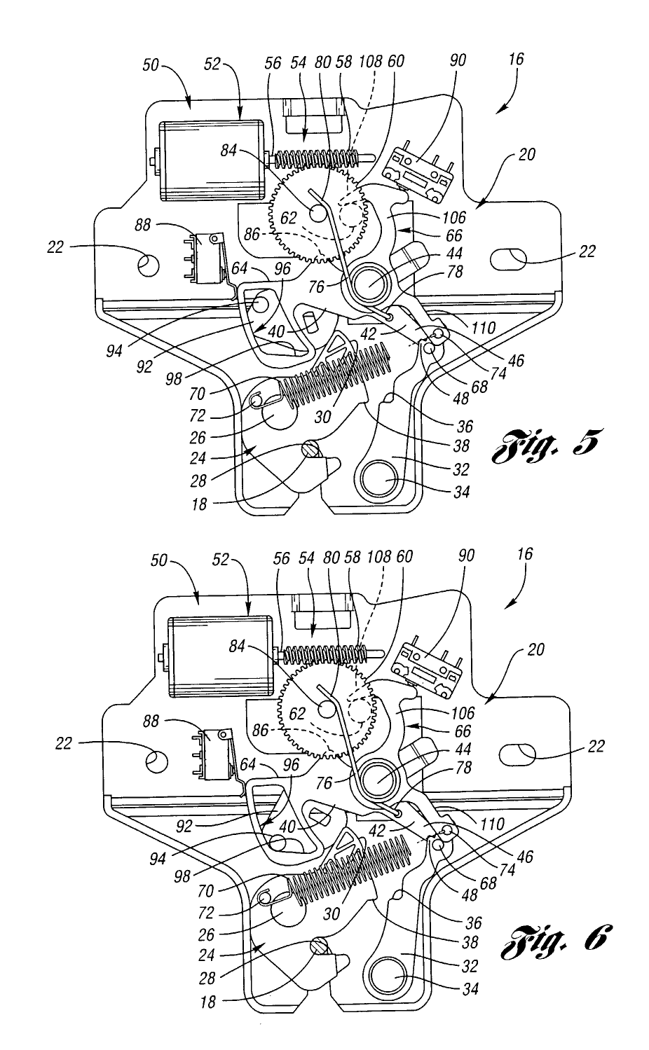

A release member 40 of the latch assembly has an actuating portion 42 and is pivotally mounted by a pin 44 on the housing 20 for actuable movement from a start position shown in FIG. 2 to a released position shown in FIG. 3. When the release member 40 is in its start position shown in FIG. 2, the catch 24 is held in the latched position by the pawl 32 in its blocking position as previously described. The actuating movement as is hereinafter more fully described moves the release member 40 to its released position of FIG. 3 where the actuating portion 42 of the release member engages and moves the pawl 32 to its released position to permit movement of the catch 24 to its unlatched position. Under normal circumstances, the catch 24 then pivots to its unlatched position of FIG. 4 as the striker 18 is released as shown in FIG. 4 and the pawl engagement portion 30 of the catch then pivots the pawl 32 clockwise and releases the actuating portion 42 of the release member 40 to permit release member movement back to its start position under a spring bias that is hereinafter described. However, when the closure member is not free to open such that the striker 18 does not move relative to the catch 24 as shown in FIG. 5 even though the pawl 32 has released the catch, a notched distal end 46 of the actuating portion 42 of release member 40 engages a lobe 48 of the pawl 32 to maintain the pawl in its released position such that the latch does not again latch and prevent opening of the closure member once the ice, snow or other accumulation etc. is removed to permit opening of the closure member.

An actuator collectively indicated by 50 is actuatable to move the release member from its start position of FIG. 2 to its released position of FIG. 3 in order to provide the pawl member movement from its blocking position to its release position for unlatching of the latch assembly. This actuator is mounted on the housing 20 and includes an electric motor 52 and worm gear drive 54 that is driven by the electric motor to provide the movement of the release member. More specifically, the electric motor 52 has a rotary output 56 that rotatively drives a worm gear 58 of the worm gear drive 54 which also includes a rotary output gear 60. This output gear 60 has a drive portion 62, and the release member 40 has a driven surface 64 that is engaged by the drive portion of the output gear 60 upon rotary driving thereof provided by the electric motor so that the release member moves from its start position of FIG. 1 to its released position illustrated in FIG. 5.

As illustrated in FIG. 2, the latch assembly 16 includes a positioning member 66 that is pivotally mounted on the housing 20 by the same pin 44 that pivotally mounts the release member 40. More specifically, this positioning member 66 is mounted for movement from the start position shown in FIG. 2 to a blocking position illustrated in FIG. 4, this movement being provided by a pin 68 on the pawl when the pawl is moved from its blocking position to its released position with respect to the catch 24. In the blocking position as illustrated in FIG. 4, the positioning member 66 engages the drive portion 62 of the output gear 60 of worm gear drive 54 to position the output gear in preparation for the next releasing actuation cycle.

As shown in FIG. 2, the latch assembly includes a spring 70 having one end secured to a pin 72 on the catch 24 and having another end secured in an opening 74 of the positioning member 66. This spring 70 biases the catch 24 to its released position of FIG. 4 and in addition biases the positioning member 66 to its start position of FIG. 2. Furthermore, engagement of the positioning member 66 with the pin 68 on the pawl also biases the pawl toward its blocking position shown in FIG. 2.

Latch assembly 16 as shown in FIG. 2 includes another spring 76 that is wound around the pin 44 and has an arm 78 extending to the release member 40 and another arm 80 extending to a shaft 84 about which the output gear 60 rotates. This spring 76 biases the release member 40 to its start position of FIG. 2. Thus, the actuating movement of the release member 40 by the electric motor driven worm gear drive 54 is against the bias of the spring 76 which thus provides pressure between the drive portion 62 of the output gear 60 and the driven surface 64 of the release member 40. Likewise, the spring 70 exerts a clockwise bias on the positioning member 66 which in turn biases the pin 68 on pawl 32 in a counterclockwise direction and in turn biases the actuating portion 42 of the release member 40 so as to also resist the actuating movement of the worm gear drive. Furthermore, it will be noted that after the output gear 60 has rotated sufficiently far to provide the latch release operation, its drive portion 62 passes over a lobe 86 of the driven surface 64 in preparation for moving back to its start position and to then also permit the release member to move back to its start position when permitted to do so by the unlatching of the latch. As previously mentioned, the positioning member 66 will then be moved to its blocking position of FIG. 5 so as to limit the rotation of the output gear 60 and position the drive portion 62 against further movement. Normally, the electric motor 62 will be electrically energized with a power duration sufficient to provide the rotary movement to the start position without maintaining the electrical supply to the motor so that it over heats after the rotation is blocked by the positioning member 66.

A sensor 88 senses the position of the release member 40 and functions to provide an alarm reset. Furthermore, a sensor 90 senses the position of the positioning member 66 to provide a closure member ajar signal.

The latch actuator also includes a key nut 92 that is rotatively moved by a key operated lock cylinder that is not shown. This key nut 92 as shown in FIG. 2 includes an actuator portion 94, and the release member 40 has an opening 96 that received the actuating portion 94 of the key nut. More specifically, the release member opening 96 has a cam surface 98 that is moved by the actuating portion 94 of the key nut 92 to move the release member from its start position shown in FIG. 5 to its released position shown in FIG. 6.

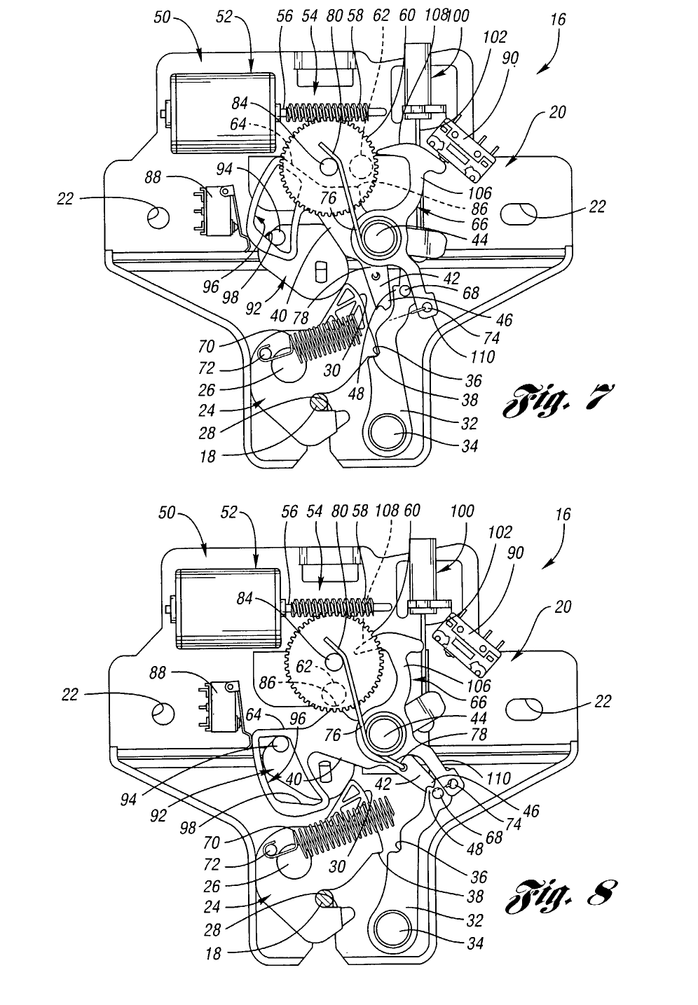

As shown in FIGS. 7 and 8, the latch assembly 16 also includes a remote cable release 100 that has a cable 102 connected to an arm 104 of the release member 40 such that pulling of the cable rotates the release member counterclockwise about the pin 44 for movement from its start position of FIG. 7 to its release position of FIG. 8.

Normally the latch assembly will have the electric motor driven worm gear drive release 54 to permit unlatching of the latch assembly by a vehicle occupant compartment actuation button, as well as having the key nut 92 for permitting exterior key release actuation of the latch assembly, and the remote cable release 100 will permit release of the latch assembly from within the trunk storage compartment as now required by certain governmental regulations.

It will be noted in FIG. 2 that the construction of the positioning member 66 includes a first arm 106 having a blocking portion 108 which moves into the path of the output gear drive portion 62 as the release member 40 is moved to its FIG. 3 release position in order to provide the positioning the output gear as previously described. A second arm 110 extends from the pin 44 that pivotally mounts the positioning member 66 and includes the hole 44 that connected to the adjacent end of the spring 70 that provides the biasing of the catch 24 to its released position and the biasing of the positioning member 66 to its start position as well as the biasing of the pawl 32 to its blocking position through the engagement of the arm 110 with the pin 66.

While the preferred embodiments for carrying out the invention have been described in detail, those familiar with the art to which this invention relates will recognize various alternative designs and embodiments for carrying out the invention as described by the following claims.

What is claimed is:

1. A vehicle latch assembly for holding a closure member in a closed position with respect to a vehicle opening defined by a vehicle body member, and the latch assembly being actuatable to permit movement of the closure member from the closed position to an open position so as to allow access through the vehicle opening, the latch assembly comprising:
a housing mountable on one of the members;
a catch pivotally mounted on the housing for movement between: a latched position for securing a striker mounted on the other member to hold the closure member in the closed position with respect to the vehicle opening, and an unlatched position that releases the striker and permits the closure member to move from the closed position to the open position, and the catch having a pawl engagement portion;
a pawl pivotally mounted on the housing for movement between: a blocking position where the pawl engages the catch to hold the catch in its latched position and thereby maintain the closure member in the closed position, and a released position where the pawl is disengaged from the catch to permit movement of the catch to the unlatched position and thereby permit movement of the closure member from the closed position to the open position;
a release member that has an actuating portion and is pivotally mounted on the housing for actuatable movement from: a start position where the catch is held in the latched position by the pawl in its blocking position, to a released position where the actuating portion of the release member engages and moves the pawl to its released position to permit movement of the catch to its unlatched position, the pawl engagement portion of the catch engaging the pawl as the catch moves from its latched position to its unlatched position as the striker is released from the catch concomitant with movement of the closure member from the closed position to the open position, and the actuating portion of the release member engaging the pawl to maintain the pawl in its released position when the catch does not move to its unlatched position because the closure member does not move from the closed position to the open position; and
an actuator for actuating movement of the release member from its start position to its released position to provide the pawl movement from its blocking position to its released position.

2. A latch assembly as in claim 1 further including a spring that biases the catch toward its unlatched position and that biases the pawl toward its blocking position.

3. A latch assembly as in claim 1 further including a spring that biases the release member toward its start position.

4. A latch assembly as in claim 1 further including a sensor that senses the location of the release member.

5. A latch assembly as in claim 1 wherein the actuator comprises an electric motor and worm gear drive that selectively moves the release member from the start position to its released position.

6. A latch assembly as in claim 5 wherein the worm gear drive includes an output gear that is rotatively driven by the electric motor, the output gear having a drive portion, and the release member having a driven surface that is engaged by the drive portion of the output gear to move the release member from its start position to its released position.

7. A latch assembly as in claim 1 wherein the actuator includes a key nut that selectively moves the release member from its start position to its released position.

8. A latch assembly as in claim 7 wherein the key nut includes an actuating portion, and the release member having an opening that receives the actuating portion of the key nut and has a cam surface that is moved by the actuating portion of the key nut to move the release member from its start position to its released position.

9. A latch assembly as in claim 1 wherein the actuator includes a remote cable release that is connected to the release member and is selectively actuable to move the release member from its start position to its released position.

10. A latch assembly as in claim 1 wherein the actuator includes: an electric motor and a worm gear drive that selectively move the release member from its start position to its released position, and a key nut that also selectively moves the release member from its start position to its released position.

11. A latch assembly as in claim 1 wherein the actuator also includes a remote cable release that is connected to the release member and is selectively actuable to move the release member from its start position to its released position.

12. A latch assembly as in claim 1 wherein the actuator includes an electric motor driven output gear having a drive portion that engages and moves the release member to move the release member from its start position to its released position, a positioning member that is moved from a start position to a blocking position when the pawl is moved from its blocking position to its released position with respect to the catch regardless of whether or not the catch moves from its latched position to its unlatched position, and the positioning member in its blocking position engaging the drive portion of the output gear to position the output gear in a start position thereof in preparation for another cycle for actuating the release member for movement from its start position to its released position.

13. A latch assembly as in claim 12 further including a spring that extends between the catch and the positioning member to bias the catch toward its unlatched position, to bias the positioning member toward its start position, and to bias the pawl toward its blocking position by engagement of positioning member with the pawl.

14. A latch assembly as in claim 13 wherein the positioning member has a first arm including a blocking portion that engages the drive portion of the output gear to position the output gear in its start position, and the position member having a second arm connected to the spring which is also connected to the catch.

15. A latch assembly as in claim 1 further including a sensor that senses the location of the positioning member.

16. A latch assembly as in claim 1 further including: a first sensor that senses the location of the release member, and a second sensor that senses the location of the positioning member.

17. A vehicle latch assembly for holding a closure member in a closed position with respect to a vehicle opening defined by a vehicle body member, and the latch assembly being actuable to permit movement of the closure member from the closed position to an open position so as to allow access through the vehicle opening, the latch assembly comprising:
a housing mountable on one of the members;
a catch pivotally mounted on the housing for movement between: a latched position for securing a striker mounted on the other member to hold the closure member in the closed position with respect to the vehicle opening, and an unlatched position that releases the striker and permits the closure member to move from the closed position to the open position, and the catch having a pawl engagement portion;
a pawl pivotally mounted on the housing for movement between: a blocking position where the pawl engages the catch to hold the catch in its latched position and thereby maintain the closure member in the closed position, and a released position where the pawl is disengaged from the catch to permit movement of the catch to the unlatched position and thereby permit movement of the closure member from the closed position to the open position;
a release member that has an actuating portion and is pivotally mounted on the housing for actuatable movement from: a start position where the catch is held in the latched position by the pawl in its blocking position, to a released position where the actuating portion of the release member engages and moves the pawl to its released position to permit movement of the catch to its unlatched position, the pawl engagement portion of the catch engaging the pawl as the catch moves from its latched position to its unlatched position as the striker is released from the catch concomitant with movement of the closure member from the closed position to the open position, and the actuating portion of the release member engaging the pawl to maintain the pawl in its released position when the catch does not move to its unlatched position because the closure member does not move from the closed position to the open position;
an actuator including an electric motor driven output gear having a drive portion that engages and moves the release member to move the release member from its start position to its released position to provide the pawl movement from its blocking position to its released position; and
a positioning member that is moved from a start position to a blocking position when the pawl is moved from its blocking position to its released position with respect to the catch regardless of whether or not the catch moves from its latched position to its unlatched position, and the positioning member in its blocking position engaging the drive portion of the output gear to position the output gear in a start position thereof in preparation for another cycle for actuating the release member for movement from its start position to its released position.

18. A vehicle latch assembly for holding a closure member in a closed position with respect to a vehicle opening defined by a vehicle body member, and the latch assembly being actuable to permit movement of the closure member from the closed position to an open position so as to allow access through the vehicle opening, the latch assembly comprising:
a housing mountable on one of the members;
a catch pivotally mounted on the housing for movement between: a latched position for securing a striker mounted on the other member to hold the closure member in the closed position with respect to the vehicle opening, and an unlatched position that releases the striker and permits the closure member to move from the closed position to the open position, and the catch having a pawl engagement portion;
a pawl pivotally mounted on the housing for movement between: a blocking position where the pawl engages the catch to hold the catch in its latched position and thereby maintain the closure member in the closed position, and a released position where the pawl is disengaged from the catch to permit movement of the catch to the unlatched position and thereby permit movement of the closure member from the closed position to the open position;
a release member that has an actuating portion and is pivotally mounted on the housing for actuatable movement from: a start position where the catch is held in the latched position by the pawl in its blocking position, to a released position where the actuating portion of the release member engages and moves the pawl to its released position to permit movement of the catch to its unlatched position, the pawl engagement portion of the catch engaging the pawl as the catch moves from its latched position to its unlatched position as the striker is released from the catch concomitant with movement of the closure member from the closed position to the open position, and the actuating portion of the release member engaging the pawl to maintain the pawl in its released position when the catch does not move to its unlatched position because the closure member does not move from the closed position to the open position;
a spring that biases the release member to is start position;
a sensor that senses the position of the release member;
an actuator including an electric motor driven output gear having a drive portion that engages and moves the release member to move the release member from its start position to its released position to provide the pawl movement from its blocking position to its released position, and the actuator also including a key nut and a remote cable release that each selectively moves the release member to move the release member from its start position to its released position to provide the pawl movement from its blocking position to its released position;
a positioning member that is moved from a start position to a blocking position when the pawl is moved from its blocking position to its released position with respect to the catch regardless of whether or not the catch moves from its latched position to its unlatched position, and the positioning member in its blocking position engaging the drive portion of the output gear to position the output gear in a start position thereof in preparation for another cycle for actuating the release member for movement from its start position to its released position;
another spring that extends between the catch and the positioning member to bias the catch toward its unlatched position, to bias the positioning member toward its start position, and to bias the pawl toward its blocking position by engagement of positioning member with the pawl; and
another sensor that senses the location of the positioning member.
